(19) United States
(12) Patent Application Publication
(10) Pub. No.: US 2018/0091340 A1
(43) Pub. Date: Mar. 29, 2018

(54) MOST LIKELY ESTIMATION SYSTEMS AND METHODS FOR CODED GMSK

(71) Applicant: Apple Inc., Cupertino, CA (US)

(72) Inventors: Konstantinos Sarrigeorgidis, Sunnyvale, CA (US); Joachim S. Hammerschmidt, Mountain View, CA (US)

(21) Appl. No.: 15/713,049

(22) Filed: Sep. 22, 2017

Related U.S. Application Data
(60) Provisional application No. 62/399,213, filed on Sep. 23, 2016.

(51) Int. Cl. H04L 27/20

(52) U.S. Cl. CPC H04L 27/2017; H04L 27/2014; H04L 27/2085

(57) ABSTRACT

Systems and methods for efficient estimation of a most likely sequence are provided. In one embodiment, an electronic device includes most likely receiver circuitry that receives a convolutional encoded signal, generates a linearized representation of the convolutional encoded Gaussian minimum-shift keying signal, resulting in a pseudo-symbol stream, estimates a most likely sequence for the pseudo-symbol stream, and decodes the pseudo-symbol stream based upon the most likely sequence.

### CROSS-REFERENCE TO RELATED APPLICATION

This application claims priority to and benefit from U.S. Provisional Application No. 62/399,213, filed Sep. 23, 2016, entitled “Most Likely Estimation Systems and Methods,” the contents of which is incorporated by reference in its entirety for all purposes.

### BACKGROUND

The present disclosure relates generally to digital communications and, more particularly, to efficient reception of Gaussian frequency shift keying (GFSK) modulated data.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Electronic devices often use wireless digital communications transmitters and/or receivers to communicate with one another. For example, such electronic devices may include computers, mobile phones, portable media devices, tablets, televisions, virtual-reality headsets, and vehicle dashboards, among many others. These devices may use frequency modulation to encode information in a carrier wave by varying the instantaneous frequency of a waveform. One particular frequency modulation that may be implemented by low-energy-long-range (LELR) technologies, such as Bluetooth®, is Gaussian Frequency-Shift Key (GFSK) modulation, which filters data pulses with a Gaussian filter to smooth transitions in the modulation.

As signals are generated and propagated from a digital communications transmitter to a digital communications receiver, noise may be incorporated into the signals, thus degrading the signals. A most likely (ML) sequence estimation (MLSE) may be used to extract useful (e.g., intended) information from noisy signals. For example, as a digital communications receiver receives the noisy signal, the receiver may determine, based upon the signal, the most likely signal communicated by the transmitter from a set of all possible signals (e.g., by comparing all hypothetical signals with an actual received signal an selecting the closest hypothetical signal). By determining the most likely signal, the receiver may estimate the signal without incorporated noise, thus providing more reliable digital communications.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

The present disclosure generally relates to improving the most likely signal estimation by reducing the complexity of the estimation calculation. As will be discussed in detail below, in certain embodiments, a frequency modulated signal (e.g., a GMSK signal) may be received at an electronic device. To provide efficient MLSE, receiver circuitry of the electronic device may transform the frequency modulated signal into a linearized representation. An augmented trellis (e.g., customized for the linearized representation) may be used to solve the most likely sequence for the linearized representation.

### BRIEF DESCRIPTION OF THE DRAWINGS

Various aspects of this disclosure may be better understood upon reading the following detailed description and upon reference to the drawings in which:

FIG. 1 is a block diagram of an electronic device with Most likely (ML) estimation circuitry, in accordance with an embodiment of the present disclosure;

FIG. 2 is one example of the electronic device of FIG. 1, in accordance with an embodiment of the present disclosure;

FIG. 3 is another example of the electronic device of FIG. 1, in accordance with an embodiment of the present disclosure;

FIG. 4 is another example of the electronic device of FIG. 1, in accordance with an embodiment of the present disclosure;

FIG. 5 is another example of the electronic device of FIG. 1, in accordance with an embodiment of the present disclosure;

FIG. 6 is block diagram illustrating transmission and reception of a frequency modulated signal, in accordance with an embodiment of the present disclosure;

FIG. 7 is a diagram illustrating a frequency pulse, in accordance with an embodiment of the present disclosure;

FIG. 8 is a block diagram illustrating frequency pulse integration, in accordance with an embodiment of the present disclosure;

FIG. 9 is a block diagram illustrating a comparison of data bits with instantaneous frequency, in accordance with an embodiment of the present disclosure;

FIG. 10 is a block diagram illustrating phase trajectory for the frequency modulated signal, in accordance with an embodiment;

FIG. 11 is a block diagram illustrating encoding and GMSK modulation, in accordance with an embodiment;

FIG. 12 is a flow chart illustrating a process for efficiently estimating a most likely sequence, in accordance with an embodiment;

FIG. 13 is a block diagram illustrating frequency modulated signal linearization, in accordance with an embodiment;

FIG. 14 is a block diagram illustrating a Laurent Decomposition for GMSK, in accordance with an embodiment;

FIG. 15 is a block diagram illustrating a modified trellis for decoding pseudo-symbols, in accordance with an embodiment;

FIG. 16 is a chart illustrating a comparison of original and modified trellis output transitions and old and new states, in accordance with an embodiment; and

FIG. 17 is a chart illustrating simulation results for the ML receiver, in accordance with an embodiment.

### DETAILED DESCRIPTION

One or more specific embodiments of the present disclosure will be described below. These described embodiments are only examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but may nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

The present disclosure provides techniques to decode frequency modulated digital communication signals. To estimate a most likely sequence from a received frequency modulated signal, in some embodiments, a receiver may be implemented that determines a linearized representation of the frequency modulated signal and estimates the most likely (ML) sequence using a trellis that is modified for the linearized domain. By linearizing the frequency modulated signal, the complexity of ML sequence estimation can be reduced significantly, while a similar digital communications error rate as a non-linearized estimation. In this manner, the techniques described herein may facilitate efficient demodulation by reducing ML sequence estimation complexity.

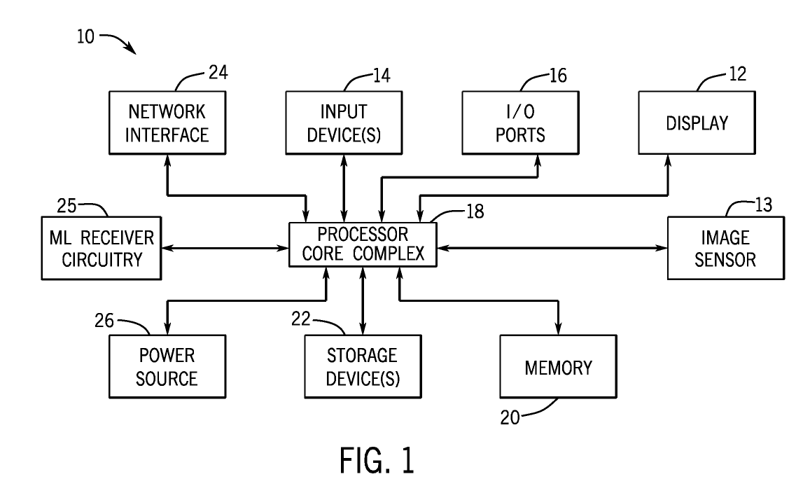

To help illustrate, an electronic device 10 that may receive a digital communications signal and estimate a most likely sequence of bits represented by the signal is shown in FIG. 1. As will be described in more detail below, the electronic device 10 may be any suitable electronic device, such as a computer, a mobile phone, a portable media device, a tablet, a television, a virtual-reality headset, a vehicle dashboard, and the like. Thus, it should be noted that FIG. 1 is merely one example of a particular implementation and is intended to illustrate the types of components that may be present in an electronic device 10.

In the depicted embodiment, the electronic device 10 includes the electronic display 12, the image sensor 13, one or more input devices 14, one or more input/output (I/O) ports 16, a processor core complex 18 having one or more processor(s) or processor cores, local memory 20, a main memory storage device 22, a network interface 24, most likely receiver circuitry 25, and a power source 26. The various components described in FIG. 1 may include hardware elements (e.g., circuitry), software elements (e.g., a tangible, non-transitory computer-readable medium storing instructions), or a combination of both hardware and software elements. It should be noted that the various depicted components may be combined into fewer components or separated into additional components. For example, the local memory 20 and the main memory storage device 22 may be included in a single component.

As depicted, the processor core complex 18 is operably coupled with local memory 20 and the main memory storage device 22. Thus, the processor core complex 18 may execute instructions stored in local memory 20 and/or the main memory storage device 22 to perform operations, such as implementing ML sequence estimation of the ML receiver circuitry 25. As such, the processor core complex 18 may include one or more general purpose microprocessors, one or more application specific processors (ASICs), one or more field programmable logic arrays (FPGAs), or any combination thereof.

In addition to instructions, the local memory 20 and/or the main memory storage device 22 may store data to be processed by the processor core complex 18. Thus, in some embodiments, the local memory 20 and/or the main memory storage device 22 may include one or more tangible, non-transitory, computer-readable mediums. For example, the local memory 20 may include random access memory (RAM) and the main memory storage device 22 may include read only memory (ROM), rewritable non-volatile memory such as flash memory, hard drives, optical discs, and/or the like.

As depicted, the processor core complex 18 is also operably coupled with the network interface 24. In some embodiments, the network interface 24 may facilitate communicating data with another electronic device and/or a network. For example, the network interface 24 (e.g., a radio frequency system) may enable the electronic device 10 to communicatively couple to a personal area network (PAN), such as a Bluetooth network, a local area network (LAN), such as an 802.11x Wi-Fi network, and/or a wide area network (WAN), such as a 4G or LTE cellular network. In this manner, the network interface 24 may enable the electronic device 10 to receive encoded modulated signals that may be interpreted by the ML receiver circuitry 25.

In some embodiments, the ML receiver circuitry 25 may process data received by the network interface 24 (e.g., via the processor core complex 18). For example, the ML receiver circuitry 25 may demodulate (e.g., by estimating a ML sequence) a frequency modulated digital communications signal received via the network interface 24. Additional details of this demodulation are provided below.

Additionally, as depicted, the processor core complex 18 is operably coupled to the power source 26. In some embodiments, the power source 26 may provide electrical power to one or more component in the electronic device 10, such as the processor core complex 18 and/or the electronic display 12. Thus, the power source 26 may include any suitable source of energy, such as a rechargeable lithium polymer (Li-poly) battery and/or an alternating current (AC) power converter.

Furthermore, as depicted, the processor core complex 18 is operably coupled with the one or more I/O ports 16. In some embodiments, an I/O ports 16 may enable the electronic device 10 to interface with other electronic devices. For example, when a portable storage device is connected, the I/O port 16 may enable the processor core complex 18 to communicate data with the portable storage device. In this manner, the I/O ports 16 may enable the electronic device 10 to output encoded image data to the portable storage device and/or receive encoded image data from the portable storage device.

As depicted, the electronic device 10 is also operably coupled with the one or more input devices 14. In some embodiments, an input device 14 may facilitate user interaction with the electronic device 10, for example, by receiving user inputs. Thus, an input device 14 may include a button, a keyboard, a mouse, a trackpad, and/or the like. Additionally, in some embodiments, an input device 14 may include touch-sensing components in the electronic display 12. In such embodiments, the touch sensing components may receive user inputs by detecting occurrence and/or position of an object touching the surface of the electronic display 12.

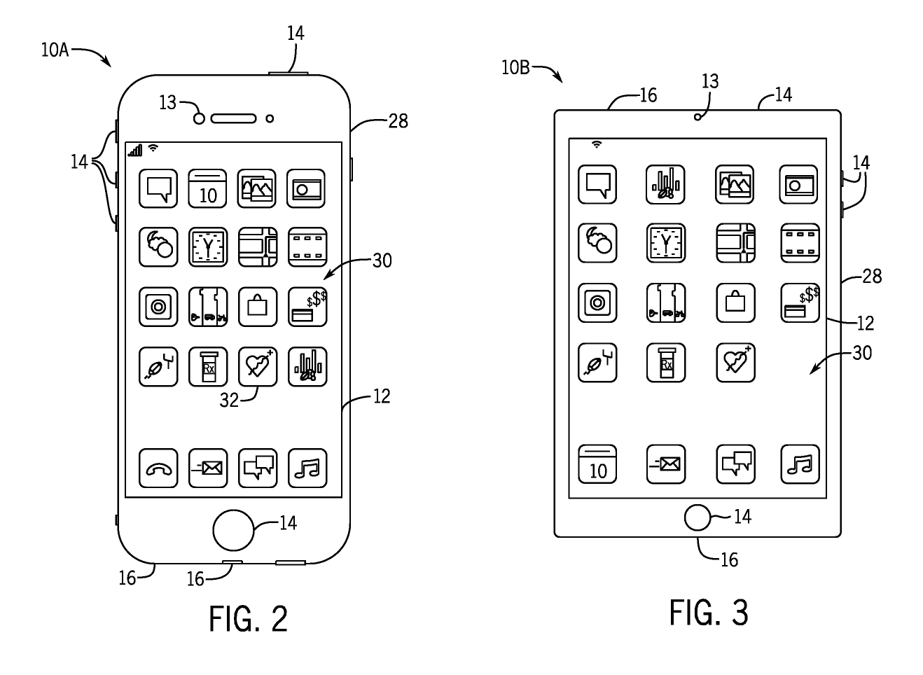

As described above, the electronic device 10 may be any suitable electronic device. To help illustrate, one example of a suitable electronic device 10, specifically a handheld device 10A, is shown in FIG. 2. In some embodiments, the handheld device 10A may be a portable phone, a media player, a personal data organizer, a handheld game platform, and/or the like. For illustrative purposes, the handheld device 10A may be a smart phone, such as any iPhone® model available from Apple Inc.

As depicted, the handheld device 10A includes an enclosure 28 (e.g., housing). In some embodiments, the enclosure 28 may protect interior components from physical damage and/or shield them from electromagnetic interference. Additionally, as depicted, the enclosure 28 surrounds the electronic display 12. In the depicted embodiment, the electronic display 12 is displaying a graphical user interface (GUI) 30 having an array of icons 32. By way of example, when an icon 32 is selected either by an input device 14 or a touch-sensing component of the electronic display 12, an application program may launch.

Furthermore, as depicted, input devices 14 open through the enclosure 28. As described above, the input devices 14 may enable a user to interact with the handheld device 10A. For example, the input devices 14 may enable the user to activate or deactivate the handheld device 10A, navigate a user interface to a home screen, navigate a user interface to a user-configurable application screen, activate a voice-recognition feature, provide volume control, and/or toggle between vibrate and ring modes. As depicted, the I/O ports 16 also open through the enclosure 28. In some embodiments, the I/O ports 16 may include, for example, an audio jack to connect to external devices.

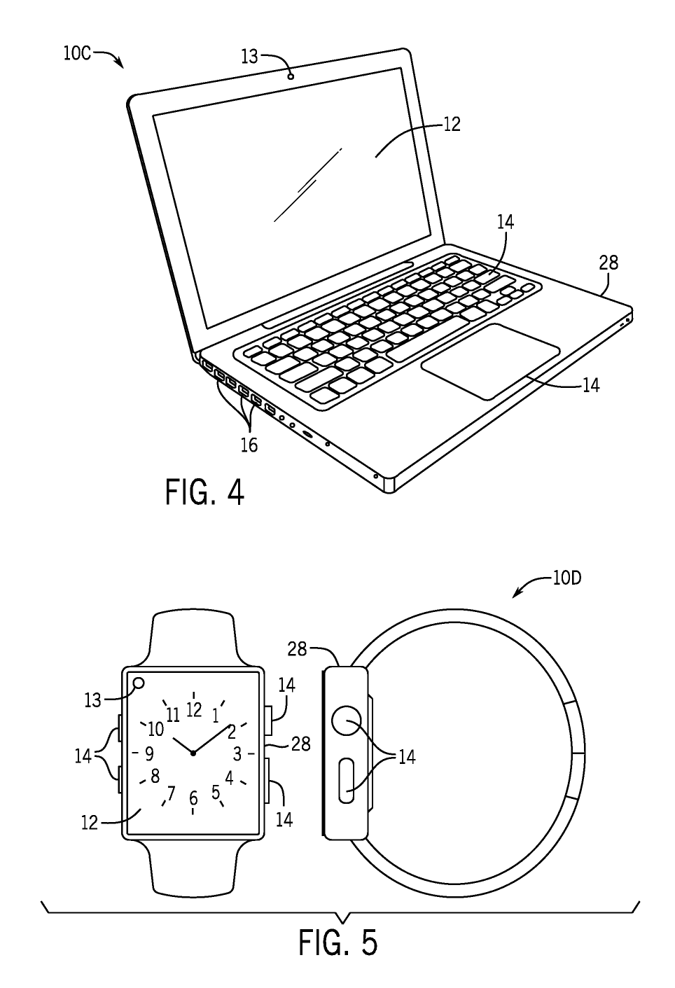

To further illustrate, another example of a suitable electronic device 10, specifically a tablet device 10B, is shown in FIG. 3. For illustrative purposes, the tablet device 10B may be any iPad® model available from Apple Inc. A further example of a suitable electronic device 10, specifically a computer 10C, is shown in FIG. 4. For illustrative purposes, the computer 10C may be any Macbook® or iMac® model available from Apple Inc. Another example of a suitable electronic device 10, specifically a watch 10D, is shown in FIG. 5. For illustrative purposes, the watch 10D may be any Apple Watch® model available from Apple Inc. As may be appreciated, the handheld device 10A, the tablet device 10B, the computer 10C, and the watch 10D may each also include features of the electronic device 10 of FIG. 1, such as a display 12, network interface 24, and ML receiver circuitry 25.

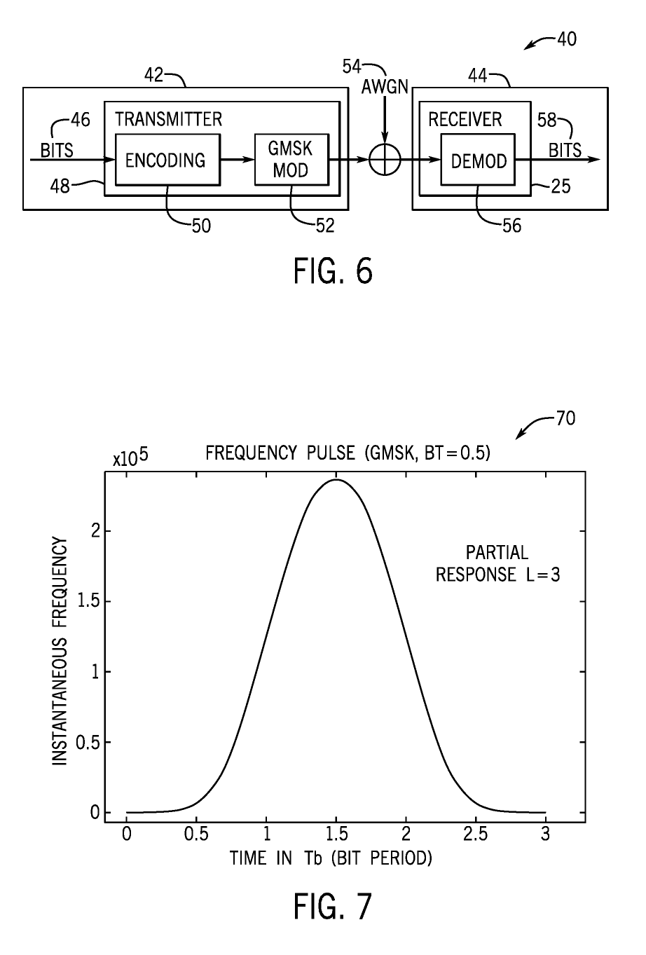

Starting first with an overview discussion of frequency modulated digital communications, FIG. 6 is block diagram illustrating a digital communications transaction 40 between a transmitting electronic device 42 and a receiving electronic device 44, using a frequency modulated signal, in accordance with an embodiment of the present disclosure. As illustrated, the transmitting electronic device 42 may desire to communicate information bits 46. Accordingly, a transmitter 48 of the transmitting electronic device 42 may encode 50 the information bits 46 and the encoded information bits 46 may then be modulated (e.g., Gaussian minimum-shift keying modulated 52 (GMSK Mod)).

During the transmission process, noise may be introduced into the modulated signal, as indicated by the additive white Gaussian noise (AWGN). Thus, the signal may degrade during transmission, introducing error into the signal.

Upon receiving the modulated signal, ML receiver circuitry 25 of the receiving electronic device 44 may demodulate 56 the modulated signal and determine the intended bits 58. To determine the intended bits 58, the ML receive circuitry 25 may estimate the maximum likely sequence from all possible bit sequences, as will be discussed in more detail below.

Turning to a more detailed discussion of the digital communication transmission, as mentioned above, Bluetooth® low-energy-long-range (LELR) employs GFSK modulation, which is a class of Continuous Phase Modulation (CPM). CPM can be generally parameterized by the modulation index (h), and the pulse frequency waveform (e.g., Gaussian bandwidth time product (BT)).

The modulation index indicates an amount of modulation of the carrier signal around its unmodulated level. In one embodiment, for CPM, the modulation index may be set to h=1/2 with a Gaussian pulse with bandwidth time product (BT)=0.5, resulting in Gaussian minimum-shift keying (GMSK) modulation. Moreover, for LELR, in some embodiments, convolutional codes may be implemented to duplicate bits for parity checking at a 1/2 code rate with a constraint length of K=4.

A CPM signal can be represented as:

$$s ( t ) = \sqrt{\frac{{E}_{b}}{{T}_{B}}} exp ( j ( ∅ ( t , a ) + {∅}_{0} ) ) , {nT}_{b} \leq t \leq ( n + 1 ) {T}_{b}$$

where Ø(t,α) is the phase modulation process that is expressible in the form:

Ø(t,a)=2πΣaᵢhq(t−iT_{b})

where α is the binary data sequence, h=2Δ_{f}T_{b} is the modulation index (Δ_{f} is the peak frequency deviation of the carrier), and q(t) is the normalized phase-response that defines how the underlying phase evolves with time. E_{b} represents the energy per bit and T_{b} represents the bit duration.

The derivative of q(t) may be defined as:

$$q ( t ) as \text{:} g ( t ) = \frac{dq ( t )}{dt}$$

$$q ( t ) = {\int }_{- ∞}^{t} g ( t ) dt$$

where g(t) is the frequency pulse.

A general CPM scheme can be described by the following parameters: modulation index h, M-ary alphabet (e.g., M=2 for binary), frequency pulse g(t), and frequency pulse duration L×Tb. A full response CPM is one whose frequency response lasts one signal interval. Otherwise, the response is partial response.

CPM signals have memory between intervals because of the phase continuity constraint. By observing multiple intervals rather than symbol by symbol (as in linear modulation), certain efficiencies may be achieved that reduce complicated ML sequence estimation, as will be discussed in more detail below. When the modulation index h is a rational number, the ML sequence estimation can be solved with a Viterbi algorithm where the observed CPM signal is equal to the actual CPM signal+noise.

In one embodiment, an MSK full response CPM scheme may be used with a modulation index h=0.5 and a rectangular frequency pulse described by:

$$g ( t ) = \{ \begin{matrix}\frac{1}{2 {T}_{b}} , & 0 \leq t \leq {T}_{b} \\ 0 , & otherwise\end{matrix}$$

For GMSK, with an h=0.5, the partial response CPM scheme may be obtained by filtering the rectangular frequency pulses of MSK with a filter having a Gaussian impulse response prior to frequency modulation of the carrier.

Equivalently, the GMSK frequency pulse can be described by the difference of two-time displaced (by T_{b} seconds) Gaussian probability integrals:

$$g ( t ) = {\frac{1}{2 {T}_{b}} [ Q ( \frac{2 π {BT}_{b}}{\sqrt{ln 2}} ( t / {T}_{b} - 1 ) ) - Q ( \frac{2 π {BT}_{b}}{\sqrt{ln 2}} ( t / {T}_{b} ) ) ]}_{formulation}^{non casual}$$

Since the Gaussian Q function is doubly infinite in extent, the GMSK frequency pulse may be time-truncated to deal with finite intersymbol interference (ISI).

FIG. 7 is a chart illustrating a frequency pulse (g(t)) 70, in accordance with an embodiment of the present disclosure. As illustrated, the depicted frequency pulse 70 spans a length of 3 symbols (e.g., L=3). The frequency pulse for GMSK, BT=0.5 and can be represented as:

$$g ( t ) = \frac{1}{4 {T}_{b}} ( Q ( \frac{2 π BT}{\sqrt{log 2}} ( \begin{matrix}t \\ {T}_{b}\end{matrix} - 2 ) ) - Q ( \frac{2 π BT}{\sqrt{log 2}} ( \begin{matrix}t \\ {T}_{b}\end{matrix} - 1 ) ) )$$

The impulse response smoothing filter limited to the interval [0, LT], L=3.

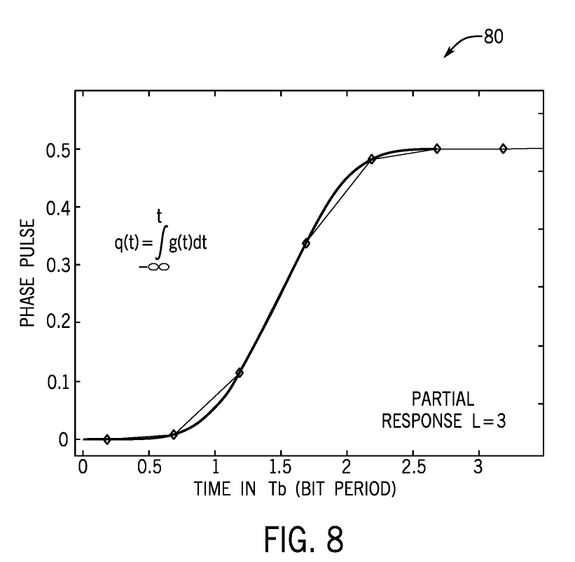

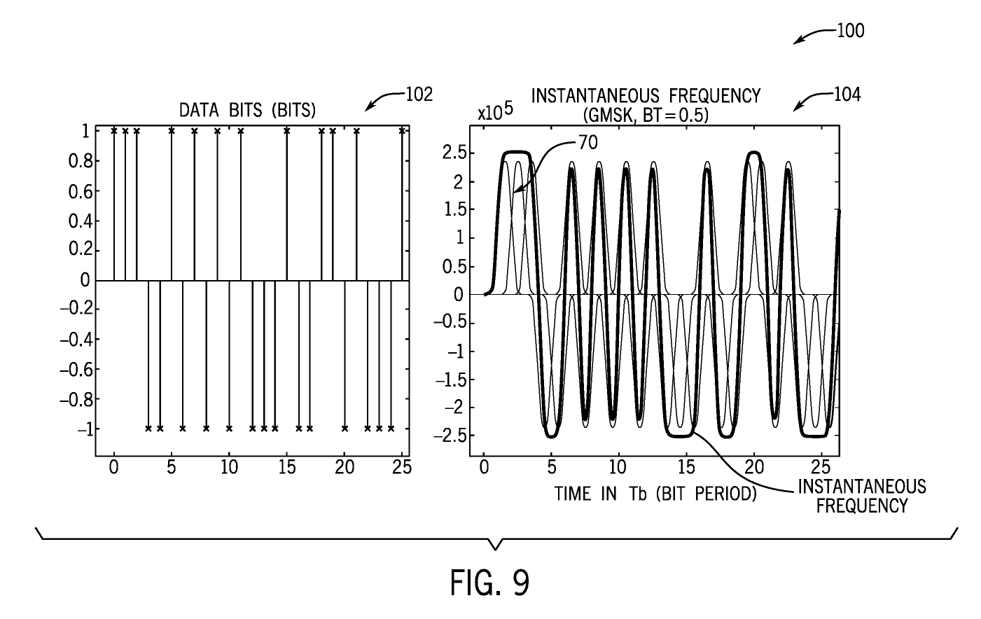

FIG. 8 is a chart 80 illustrating frequency pulse integration, in accordance with an embodiment of the present disclosure. The chart 80 illustrates phase shaping filter coefficients for GMSK with BT=0.5, (L=3, OVS=2).

FIG. 9 is a block diagram illustrating a comparison 100 of data bits 102 with instantaneous frequency 104, in accordance with an embodiment of the present disclosure. As illustrated, the instantaneous frequency 104 may be derived by frequency pulses 70 that are instantiated to correspond to the data bits 102. As mentioned above, the modulation index (h) may be derived as follows:

$$h = \frac{2 {f}_{d}}{{f}_{b}} = 2 {f}_{d} {T}_{b}$$

$$h = 1 / 2 ⇒ {f}_{d} = {f}_{b} / 4 = 250 kHz$$

$${f}_{d} = {f}_{b} / 4 = 2.5 e5 Hz$$

f_{d} represents the peak frequency deviation. T_{b} is the symbol period.

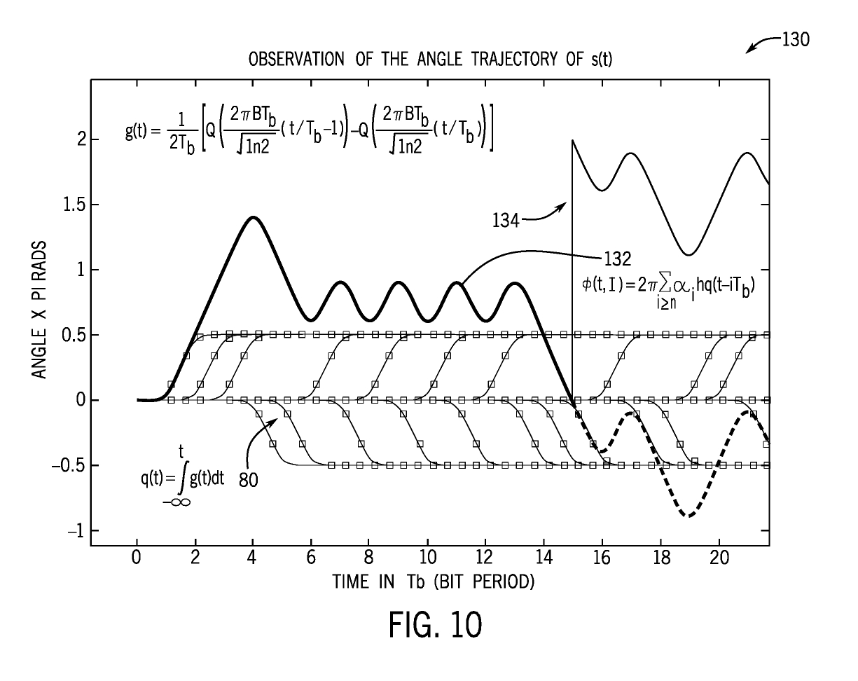

FIG. 10 is chart illustrating phase trajectory 130 for the frequency modulated signal, in accordance with an embodiment. As illustrated in chart 80, the phase pulses may be represented by:

$$q ( t ) = {\int }_{- ∞}^{t} g ( t ) dt$$

Further. the total phase 132 may be represented by:

$$∅ ( t , I ) = 2 π {\sum }_{i \leq n}^{ } {a}_{i} hq ( t - {iT}_{b} )$$

Additionally, the mod(total phase, 2pi) 134 is illustrated in FIG. 10. This can be represented by:

$$g ( t ) = \frac{1}{2 {T}_{b}} [ Q ( \frac{2 π {BT}_{b}}{\sqrt{ln 2}} ( t / {T}_{b} - 1 ) ) - Q ( \frac{2 π {BT}_{b}}{\sqrt{ln 2}} ( t / {T}_{b} ) ) ]$$

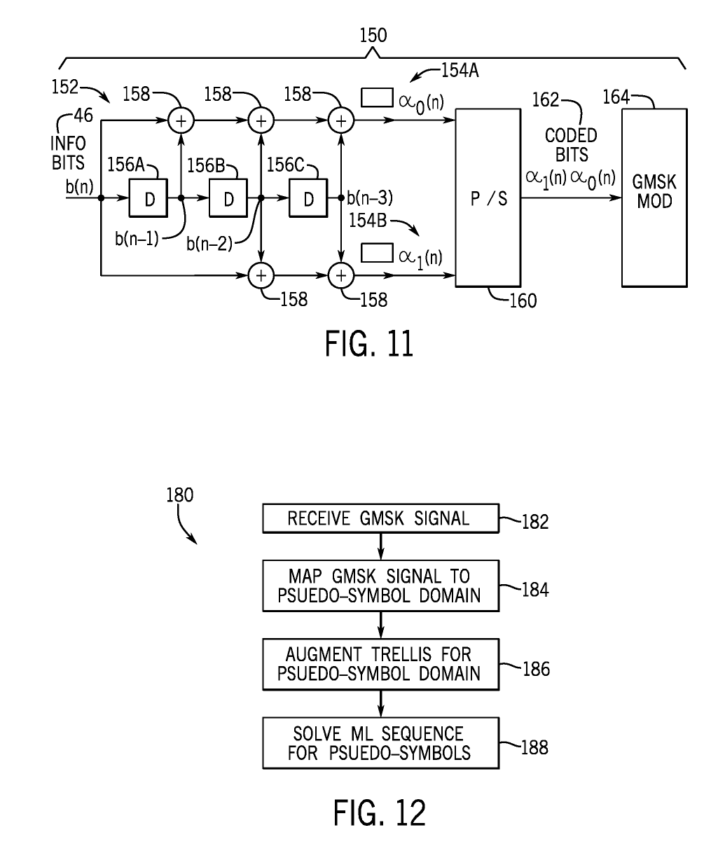

Turning now to a discussion of convolution encoding modulated signals, FIG. 11 is a block diagram illustrating circuitry 150 for encoding a GMSK modulation, in accordance with an embodiment. As previously discussed with regard to FIG. 6, information bits 46 (e.g., represented here as b(n)) are encoded. For example, in the embodiment of FIG. 11, a convolutional encoder 152 is used to generate symbols (e.g., symbols α₀(n) 154A and α₁ (n) 154B) via a sliding application of a Boolean polynomial function to the information bits 46. For example, the information bits b(n) 46 are passed through the shift registers 156A, 156B, and 156C (e.g., as represented by b(n−1), b(n−2), and b(n−3)) and XOR logic 158 to derive the symbols 154A and 154B, represented by α₀(n) and α₁(n).

The symbols 154A and 154B are provided to the P/S 160, resulting in coded bits 162 (e.g., represented here by: α₁(n)α₀(n). The coded bits 162 may then be GMSK modulated, as represented by block 164.

The received signal over N symbol intervals may be represented by:

s(t,b)=e^{jØ(t,b)}+NOISE

To estimate the transmitted bit sequence b, the receiver 25 may minimize:

$${min}_{\hat{b}} {\int }_{0}^{NT} {\vert s ( t , b ) - {e}^{j ∅ ( t \hat{b}} \vert}^{2} dt$$

where s(t, b) is a waveform as a function of time and the transmitted bits.
However, such minimization may be quite complex, as 2̂N hypothetical sequences are compared to the received signal. Accordingly, another approach that provides less complex comparison may be desirable.

In certain embodiments, the Viterbi algorithm may be used to facilitate estimation of the most likely sequence. The following discussion provides an enhanced approach for estimating the most likely sequence using the Viterbi algorithm.

The information carrying phase is given by:

$$ϕ ( t , a ) = π h {\sum }_{k = - ∘}^{n - 3} a [ k ] + 2 π h {\sum }_{k = - 3 + 1}^{n} a [ k ] q ( t - kT ) , nT \leq T \leq ( n = 1 ) T$$

The accumulated phase may be represented by:

Θ[n−3]=πhΣₖ₌₋ₒ^{n-L}a[k]

T=T_{b}

L=3

The first part of this representation is the previously discussed memory of the signal (e.g., all of the pulses except for the most recent pulses (Θ[n−L]). As mentioned above, L is length of the frequency pulse 70, in terms of symbols. Each of these pulses have already imprinted on the memory. The second part of this representation is summation of the symbols that have a contribution from previous bits.

The sum of the phase contribution due to the most recent symbol (α[n]) and the state (α[n−1], α[n−2]) may be represented by:

$${\sum }_{k = - n - L + 1}^{n} a [ k ] q ( t - kT )$$

Therefore, the state vector may be represented by:

Sₙ={Θ[n−3]a[n−1]a[n−2]}

There are 4 possible values for Θ and α[n] may be +/−1, as illustrated below:

a[n]∈±1,Θ[n]∈[0π/2π3π/2]

Thus, 2̂4 values are possible for the Viterbi algorithm. Thus, there are 16 states for the Viterbi algorithm in the IQ domain without coding.

However, when additional memory is present due to encoding (e.g. due to the convolutional encoding by the convolutional encoder 152 of FIG. 11), additional states may be used. For example, the state vector may be represented as:

$${S}_{n} \{ Θ ( {{b}_{n - k}}_{k > 4} ) {b}_{n - 1} {b}_{n - 2} {b}_{n - 3} {b}_{n - 4} \}$$

The received signal over N symbol intervals may be represented as:

s(t,b)=e^{jφ(t,b)}+noise

The ML receiver 25 may attempt to estimate the transmitted bit sequence b by minimizing:

$${min}_{\hat{b}} {\int }_{0}^{NT} {\vert s ( t , b ) - {e}^{j ϕ ( t \hat{b} )} \vert}^{2} dt$$

However, this estimation may use 64 states for the Viterbi algorithm in the IQ domain. Thus, this algorithm may be quite complex, as the branch metric computations involve multiplication with complex samples in (I, Q) domain.

Accordingly, the discussion turns to a more efficient process for estimating the most likely sequence. FIG. 12 is a flow chart illustrating a process 180 for efficiently estimating a most likely sequence, in accordance with an embodiment. As previously discussed, a GMSK modulated signal may be received (block 182).

The GMSK modulated signal may be mapped to the pseudo-symbol domain (block 184). For example, as will be discussed in more detail below, an equivalent and linearized representation of the GMSK modulated signal may be determined.

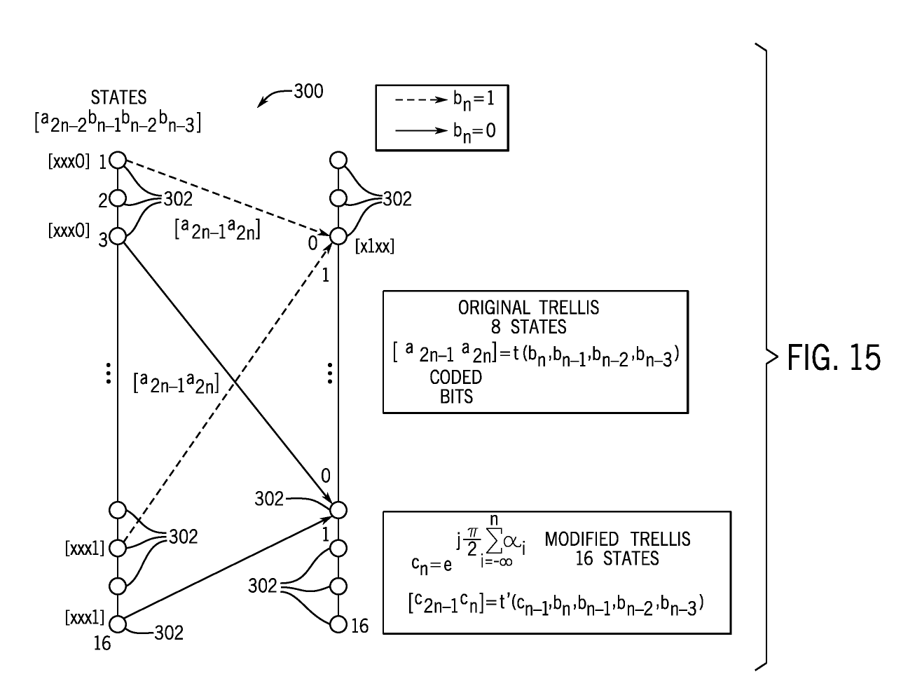

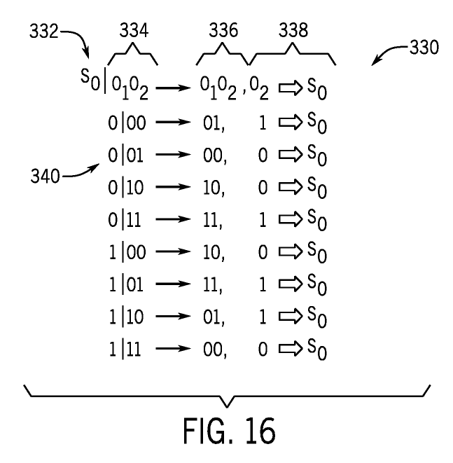

Based upon the pseudo-symbol domain representation of the GMSK modulated signal, a trellis may be augmented (block 186). As may be appreciated, a trellis provides each available sequence for a set hidden states. The discussion regarding FIGS. 15 and 16 below go into a more detailed discussion of how the trellis may be modified for the pseudo-symbol domain.

After the trellis is augmented, the most likely sequence for the pseudo-symbol representation of the signal is determined using the augmented trellis (block 188). This most likely sequence is used to validate the inferred bits of signal, enabling these bits to be used by a receiving electronic device.

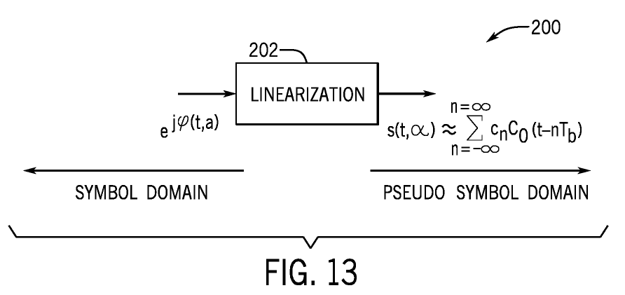

Turning now to a discussion of the linearization to the pseudo-symbol domain step of process 180 (e.g., block 184), FIG. 13 is a block diagram 200 illustrating linearization circuitry 202 for frequency modulated signal linearization, in accordance with an embodiment. As mentioned above, in the linearization step, the linearization circuitry 202 may generate a linearized representation of the GMSK signal. In other words, a pseudo-symbol domain representation of the symbol domain may be generated. In essence, this process maps a GMSK (or GFSK) scheme onto a newer scheme, represented by superposition of pulses rather than modularity of the carrier signal directly. Based upon the modulation index, the linearized representation finds the waveforms C(t) and coefficients αₙ that can best describe the waveform: e^{jφ(t,α)}.

The linearized representation may be represented by:

$$s ( t , a ) \approx {\sum }_{n = - ∘}^{n = - ∘} {c}_{n} {C}_{0} ( t - {nT}_{b} )$$

The linearization may be based on Laurent Decomposition. The decomposition may include pulses and pseudo-symbols for each pulse. For example, the GMSK signal can be written as:

$$( t , a ) = {\sum }_{K = 0}^{{2}^{L - 1}} {e}^{j \frac{π}{2} {A}_{K , n}} {C}_{K} ( t - {nT}_{b} ) ,$$

where
C_{K} represents “K” number of pulses and

$${e}^{j \frac{π}{2} {A}_{K , n}}$$

represents the pseudo-symbols.
The first summation is across different pulses and the second summation is across time.

If we define:

$$Ψ ( t ) = \{ \begin{matrix}π q ( t ) & 0 \leq t \leq {LT}_{b} \\ \frac{π}{2} [ 1 - 2 q ( t - {LT}_{b} ) ] & {LT}_{b} \leq t\end{matrix} ,$$

then:

S₀(t)=sin(Ψ(t))

Sₙ(t)=sin(Ψ(t+nT)).

Further, the pulses are products of time-shifted basis function and may be represented as:

$${C}_{k} ( t ) = {S}_{0} ( t ) {\prod }_{i = 1}^{L - 1} {S}_{i + L {β}_{Kj} ( t ) , 0 \leq K \leq {2}^{L - 1} - 1 , 0 \leq T \leq {T}_{bK}}$$

$${T}_{bK} = {T}_{b} \times {min}_{i = 1 , 2 , … L - 1} [ L ( 2 - {β}_{K , i} ) - i ] duration of Kth pulse$$

β_{K,i} is the binary representation of K

β_{K=1}=100

β_{K=2}=010

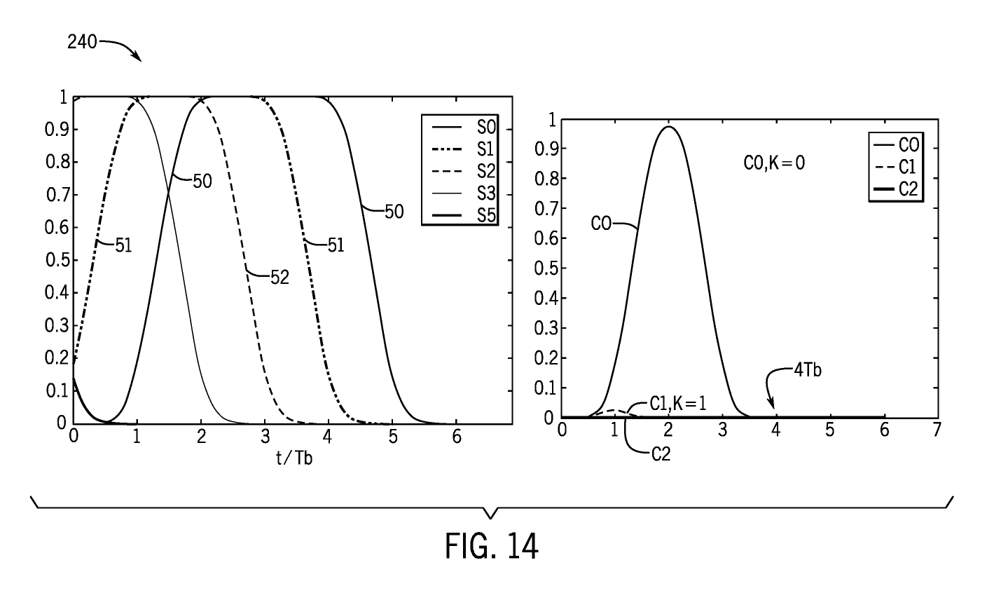

FIG. 14 provides charts 240, illustrating a Laurent Decomposition for GMSK, in accordance with an embodiment. In

$${C}_{k} ( t ) = {S}_{0} ( t ) {\prod }_{i = 1}^{L - 1} {S}_{I + L {β}_{Kj}} ( t ) , 0 \leq K \leq {2}^{L - 1} - 1 , 0 \leq T \leq {T}_{bK}$$

$${T}_{bK = 0} = {T}_{b} \times {min}_{i = 1 , 2 , … L - 1} [ L ( 2 - {β}_{K , j} ) - i ] = {T}_{b} \times [ 3 ( 2 - 0 ) - 3 + 1 ] = 4 {T}_{b}$$

$${C}_{0} ( t ) = {S}_{0} ( t ) {S}_{1} ( t ) {S}_{2} ( t )$$

$${C}_{1} ( t ) = {S}_{0} ( t ) {S}_{4} ( t ) {S}_{2} ( t )$$

As illustrated in the charts 240, 99.2% of the energy is on C0(t). Accordingly, A_{0,n} can be computed.

A_{0,n} can be represented as:

$${A}_{0 , n} = {a}_{i} \cdot Let {C}_{n} = {e}^{j \frac{π}{2} {A}_{0 , n}}$$

Further, the pseudo-symbols may be represented by:

$${C}_{n} = {e}^{j \frac{π}{2}} {a}_{i}$$

It can be seen that:

Cₙ=jaₙcₙ₋₁

Thus:

$$s ( t , a ) \approx {c}_{n} {C}_{0} ( t - {nT}_{b} )$$

Therefore the GMSK (BT=0.5) can be approximated as two overlapped differential binary phase-shift keying (BPSK) signals (e.g., rotated by pi/2). It can be seen that:

{c₂ₙ}∈{1,−1},{c₂ₙ₌₁}∈{j,−j}.

Therefore, the transmission (Tx) imposes a differential encoding rule to the data, represented as:

Cₙ=jaₙcₙ₋₁.

The received signal may be represented as:

$$y ( t ) = s ( t , a ) + n ( t ) \approx {\sum }_{n = - ∞}^{n = ∞} {c}_{n} {C}_{0} ( t - {nT}_{b} ) + n ( t )$$

Further, a metric may be defined:

$$J = {\int }_{0}^{{T}_{0}} {\vert y ( t ) - {\sum }_{n = 0}^{L} {C}_{0} ( t - {nT}_{b} ) \vert}^{2} dt$$

This can be written as:

$$J = {E}_{y} - 2 {R}_{e} \{ {∮}_{0}^{T} y ( t ) {s ( t , \tilde{a} )}^{*} dt \} + {\sum }_{k = 0}^{K - 1} {\sum }_{k = 0}^{K - 1} {c}_{k} {c}_{j}^{*} {ρ}_{h} ( j - k )$$

If we also assume that the noise is white and Gaussian (e.g., is it ML), we can represent the likelihood function as:

$$Λ ( \tilde{a} ) = Re \{ {∮}_{0}^{T} y ( t ) {s ( t , \tilde{a} )}^{*} dt \} Re \{ {\sum }_{n} {c}_{n}^{*} {∮}_{0}^{T} y ( t ) {{c}_{0} ( t - {nT}_{b} )}_{dt} \} \approx Re \{ {\sum }_{n} {c}_{n}^{*} {r}_{n} \}$$

$$Where \text{:}$$

$${r}_{n} = {\int }_{- ∞}^{∞} y ( t ) {C}_{0} ( t - {nT}_{b} ) = y ( t ) ⊗ {C}_{0} ( - T ) {\vert}_{t = nT}$$

Therefore, a search for sequence b(n) maximizes:

$$Λ ( \tilde{a} ) = Re \{ {\sum }_{n} {\tilde{a}}_{n}^{*} {r}_{n} \}$$

Where: Λ(\tilde{α}) is the hypothetical sequence and Σₙãₙ*rₙ is the pseudo-symbols.

FIG. 15 is a block diagram illustrating a trellis 300 for decoding pseudo-symbols, in accordance with an embodiment. Viterbi-based trellises may use 8 states, according to the equation:

$$[ \begin{matrix}{a}_{2 n - 1} {a}_{2 n} \\ coded \\ bits\end{matrix} ] = t ( {b}_{n} , {b}_{n - 1} , {b}_{n - 2} , {b}_{n - 3} )$$

However, as illustrated in FIG. 15, the trellis 300 may be modified to solve the ML sequence estimation for the Pseudo-symbols, by adding 8 additional states 302. Accordingly, the modified trellis 300 may use 16 states 302, according to the equations:

$${C}_{n} = {e}^{j \frac{π}{2}} {\sum }_{i = - ∞}^{n} {a}_{i} \\ [ {c}_{2 n - 1} {c}_{n} ] = {t}^{1} ( {c}_{n - 1} , {b}_{n} , {b}_{n - 1} , {b}_{n - 2} , {b}_{n - 3} )$$

FIG. 16 is a chart illustrating additional details of the modifications 330 to the trellis 300 of FIG. 15, in accordance with an embodiment. Because the symbols of the GMSK signal have been transformed into the pseudo-symbol domain, the output bits for each of the transitions in the trellis 300 may be translated into the pseudo-symbol domain. For example, in the table of modifications 330, the output bits for each transition of the original trellis are represented by:

O₁O₂

Further, the output bits for each transition of the modified trellis are represented by:

O₁′O₂′

The states are represented by:

s=(s₀s₁s₂s₃)

Further, the S₀ state is updated by O₂′.

Accordingly, the chart illustrates the old S₀ state 332, the original trellis output transitions O₁O₂ 334, the modified trellis output transitions O₁′O₂′ 326, and the new S₀ state 338, which is derived from O₂′. As an example of a modification that is made to the trellis 300, based upon the modifications 330, assuming that S₀ is “0” in the original trellis 300 and that the original output bits O₁O₂ 334 are “01”, then the modified output bits O₁′O₂′ 326 would be transitioned to “00” and S₀ would remain “0”, as dictated by row 340.

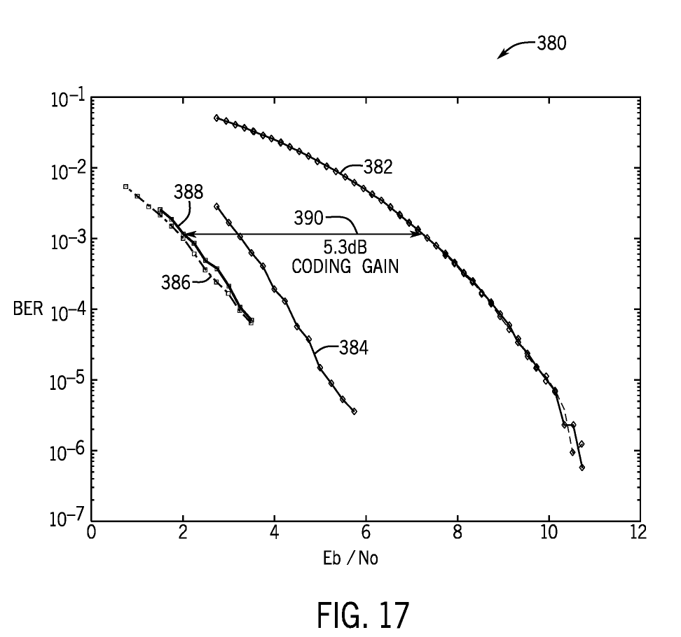

As may be appreciated, using the pseudo-symbol representation and the modified trellis, the complexity of the estimating the ML sequence becomes much less complex, reducing processing burdens on receiving electronic devices. Despite this significant reduction in complexity, bit error rates (BER) are similar to a receiver that implements the more complex estimation. FIG. 17 is a chart illustrating simulation results 380 for the ML receiver, in accordance with an embodiment. Line plot 382 illustrates BER vs E_{b}/Nₒ for a GMSK uncoded signal. Line plot 384 illustrates a plot for GMSK rate 1/2, having a soft decode with 8 states, and dmin=6, K=4. Line plot 386 illustrates a signal decoded via the complex estimation (e.g., GMSK rate 1/2), as described above. Additionally, line plot 388 illustrates the decoding with 16 states, using the pseudo-symbols.

As may be appreciated from the simulation results 380, despite the less-complex estimation process of the decoding, the line plot 388 is quite close in bit error rates as line plot 386. Further, as illustrated by arrow 390, the line plots 386 and 388 result in a 5.3 dB coding gain over the uncoded signals (e.g., represented by line plot 382).

Accordingly, the technical effects of the present disclosure include facilitating efficient estimation of a most likely sequence for a frequency modulated digital communications signal. In particular, through linearization, a digital communications receiver may reduce the complexity in ML sequence estimation, while maintaining low error rates in the digital communications.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

What is claimed is:

1. An electronic device, comprising:
most likely receiver circuitry, configured to:
receive a convolutional encoded signal;
generate a linearized representation of the convolutional encoded signal, resulting in a pseudo-symbol stream;
estimate a most likely sequence for the pseudo-symbol stream; and
decode the pseudo-symbol stream based upon the most likely sequence.

2. The electronic device of claim 1, wherein:
the convolutional encoded signal is modulated according to a continuous phase modulation scheme.

3. The electronic device of claim 2, wherein the continuous phase modulation scheme comprises a modulation index (h) equal to 0.5.

4. The electronic device of claim 2, wherein:
the continuous phase modulation scheme comprises a Gaussian minimum-shift keying modulation scheme (GMSK).

5. The electronic device of claim 4, comprising:
estimating the most likely sequence using a trellis augmented for the pseudo-symbol stream.

6. The electronic device of claim 5, wherein the trellis is augmented to allow for 16 states.

7. The electronic device of claim 5, wherein a second output bit (O₂′) of the trellis updates a state (S₀).

8. The electronic device of claim 4, wherein:
the GMSK is approximated as two overlapped differential binary phase-shift keying (BPSK) signals.

9. The electronic device of claim 8, wherein the two overlapped differential BPSK signals are rotated by pi/2.

10. The electronic device of claim 1, wherein the linearized representation is based upon a Laurent Decomposition.

11. The electronic device of claim 1, wherein the electronic device comprises: a computer, a mobile phone, a portable media device, a tablet computer, a television, an electronic watch, a virtual-reality headset, a vehicle dashboard, or any combination thereof.

12. The electronic device of claim 1, wherein the most likely sequence is estimated using a Viterbi algorithm.

13. A tangible, non-transitory, machine-readable medium, comprising machine-readable instructions that, when executed by a processor, cause the processor to:
receive a convolutional encoded signal;
generate a linearized representation of the convolutional encoded signal, resulting in a pseudo-symbol stream;
estimate a most likely sequence for the pseudo-symbol stream; and
decode the pseudo-symbol stream based upon the most likely sequence.

14. The machine-readable medium of claim 13, comprising instructions to generate the linearized representation of the convolutional encoded signal, by generating a pseudo-symbol representation of a symbol domain associated with the convolutional encoded signal, resulting in the pseudo-symbol stream.

15. The machine-readable medium of claim 14, comprising instructions to map a Gaussian Minimum Shift Keying (GMSK) or Gaussian Frequency Shift Keying (GFSK) scheme onto an alternative scheme that is represented by superposition of pulses rather than modularity of a carrier signal.

16. The machine-readable medium of claim 14, comprising instructions to estimate the most likely sequence using a trellis modified to use 16 states for estimation of pseudo-symbols.

17. Electronic modulated transmission receiver circuitry, comprising:
reception circuitry, configured to receive a convolutional encoded signal;
linearization circuitry, configured to generate a linearized representation of the convolutional encoded signal, resulting in a pseudo-symbol stream;
estimation circuitry, configured to estimate a most likely sequence for the pseudo-symbol stream; and
decoding circuitry, configured to decode the pseudo-symbol stream based upon the most likely sequence.

18. The electronic modulated transmission receiver circuitry of claim 17, wherein the estimation circuitry is configured to estimate the most likely sequence using a Viterbi algorithm.

19. The electronic modulated transmission receiver circuitry of claim 17, wherein the convolutional encoded signal comprises a Gaussian Frequency-Shift Key (GFSK) modulation.

20. The electronic modulated transmission receiver circuitry of claim 17, wherein the estimation circuitry is configured to estimate the most likely sequence using an augmented trellis that is customized for the linearized representation of the convolutional encoded signal.
